(19) United States
(12) Patent Application Publication
(10) Pub. No.: US 2026/0008054 A1
(43) Pub. Date: Jan. 8, 2026

(54) SEQUENTIAL PUMPING BY MEANS OF AN ACTUATOR

(71) Applicant: Hahn-Schickard-Gesellschaft fuer angewandte Forschung e.V., Villingen-Schwenningen (DE)

(72) Inventors: Laura NIEBLING, Freiburg (DE); Jan-Niklas KLATT, Freiburg (DE); Nils PAUST, Freiburg (DE); Tobias HUTZENLAUB, Ettenheim (DE)

(21) Appl. No.: 19/324,797

(22) Filed: Sep. 10, 2025

Related U.S. Application Data
(63) Continuation of application No. PCT/EP2024/056229, filed on Mar. 8, 2024.

(30) Foreign Application Priority Data
Mar. 10, 2023 (DE) 10 2023 202 206.0

(51) Int. Cl. B01L 3/00

(52) U.S. Cl. CPC B01L 3/50273; B01L 3/502715; B01L 2200/0621; B01L 2300/0816; B01L 2300/087; B01L 2300/1822; B01L 2300/1894; B01L 2400/0442; B01L 2400/0457

(57) ABSTRACT

A centrifugal-microfluidic cartridge module for operation in a centrifugal-microfluidic device and/or centrifuge, having: a first chamber configured to receive a liquid and/or gas and to provide the same with an underpressure or overpressure in relation to a starting pressure by a pressure generator; a second chamber; a third chamber; and a node connected to the chambers via a fluidic network, which has a first partial channel connecting the node to the first chamber, a second partial channel connecting the node to the second chamber, and a third partial channel connecting the node to the third chamber; a second channel connecting the second and third chambers and opening in a radially outer region and having at least one radially inwardly directed portion; the third partial channel having a portion which, as seen radially, is further inward than the second partial channel.

### CROSS-REFERENCE TO RELATED APPLICATIONS

This application is a continuation of copending International Application No. PCT/EP2024/056229, filed Mar. 8, 2024, which is incorporated herein by reference in its entirety, and additionally claims priority from German Application No. 10 2023 202 206.0, filed Mar. 10, 2023, which is also incorporated herein by reference in its entirety.

### TECHNICAL FIELD

Embodiments of the present invention relate to a centrifugal-microfluidic cartridge module and to a corresponding method for operating the centrifugal-microfluidic cartridge module. Preferred embodiments relate to sequential pumping by means of an actuator.

### BACKGROUND OF THE INVENTION

Microfluidics and their subtype of centrifugal microfluidics, in which the microfluidics are rotated for liquid actuation, are concerned with handling liquids in the fl-ml range. Such systems are often disposable polymer cartridges since they have great potential for cheap mass production. As a result, standard laboratory processes, such as e.g. pipetting, centrifuging, mixing or aliquoting, can be implemented in a centrifugal-microfluidic cartridge and complete laboratory processes can be automated. For this purpose, the cartridges contain channels for fluid guiding, and chambers for collecting liquids. Centrifugal microfluidics are applied, inter alia, in laboratory analysis and diagnostics.

It is to be noted here that the focus of microfluidics is processing fluids; these fluids can have both a liquid and a gaseous state. In this respect, it is to be understood that the microfluidic devices are also suitable for gases.

For many possible applications, such as e.g. extracting and purifying DNA, liquid reagents, such as e.g. lysis, binding, washing and elution buffers, are at first pumped from a respective pre-storage chamber into a reaction chamber and, after reaction, pumped into one or different target chambers. A separate actuator is generally required for each individual one of these pumping processes, in particular when the reaction chamber is vented. In addition to other possibilities, temperature or frequency changes are often used as actuation principles in centrifugal microfluidics in order to generate the necessary pressure in compression chambers and thus to enable liquid transport (for example by enclosing a gas volume in a compression chamber at a comparatively high rotation frequency by means of liquid and compressing it by means of hydrostatic pressure). When changing to a comparatively lower rotation frequency, the gas expands and can be used as a pumping mechanism). A disadvantage of current solutions is the space requirement due to a multitude of compression chambers in order to be able to realize sequential pumping steps. Therefore, there is need for an improved approach.

The known technology will be discussed below, and further problems will be discussed here. In particular, identifying problems is already part of the solution and is therefore to be considered as part of the invention.

A selection of common methods for liquid transport in centrifugal-microfluidic cartridges is described below.

In the publication by T. H. G. Thio et al. entitled “Push pull microfluidics on a multi-level 3D CD” Lab Chip, 2013, 13, 3199-3209, a microfluidic structure is described (FIG. 2) which has a compression chamber which is at first heated. The overpressure is used to switch liquid via a siphon from a chamber B into the chamber A located radially further to the outside. Subsequently, the compression chamber is cooled and thus the liquid is drawn back into the outlet chamber B via the same siphon by means of underpressure.

In the publication by P. Julg et al. entitled “Automated serial dilutions for high-dynamic-range assays enabled by fill-level-coupled valving in centrifugal microfluidics” Lab Chip, 2019, 19, 2205-2219, a microfluidic structure is described which, depending on the fill level in a chamber, enables switching/pumping into a further chamber. Similarly to the patent strived for, transfer is enabled by a channel (FIG. 3, top left: fill-level-coupled siphon) being partially filled with liquid at a certain point in time and thus no longer being accessible to gas. As a result, the liquid is pumped further via a further channel (transfer siphon).

In L. Malic et al. entitled “Automated sample-to-answer centrifugal microfluidic system for rapid molecular diagnostics of SARS-COV-2” Lab Chip, 2022, 22, 3157-3171, in principle a centrifugal-microfluidic platform is used, which is connected to an external compressed air system (FIG. 4). Here, the chambers and channels of the microfluidic chip can be provided with overpressure or underpressure via several ports (“pressure ports”). In the present example, port 1 is at first operated under overpressure in order to mix a liquid, then under underpressure in order to switch the liquid into a chamber via a siphon.

The patent DE102016207845A1 & family describe a fluidic structure which enables a siphon to be primed by temporarily building up a pressure difference in a microfluidic cartridge and thus to trigger a valve function (FIG. 5).

The object underlying the present invention is to provide an improved concept for the actuator system between at least three chambers.

### SUMMARY

According to an embodiment, a centrifugal-microfluidic cartridge module for operation in a centrifugal-microfluidic device and/or centrifuge so that the cartridge module is rotatable about a rotation center, may have: means for generating pressure; wherein the means for generating pressure have heating and/or cooling means configured to generate the overpressure by means of a temperature increase and the underpressure by means of a temperature reduction; a first chamber configured to receive a liquid and/or gas and to provide the liquid and/or the gas with an underpressure and/or overpressure in relation to a starting pressure by means of the means for generating pressure; a second chamber; a third chamber; and a node which is connected to the first, second and third chambers via a fluidic network, wherein the fluidic network has a first partial channel which connects the node to the first chamber, a second partial channel which connects the node to the second chamber, and a third partial channel which connects the node to the third chamber; wherein a second channel connects the second and third chambers to each other and opens in a radially outer region or at the radially outer end of the second chamber and has at least one radially inwardly directed portion; wherein the third partial channel has a portion which, as seen radially, is further inward than the second partial channel.

According to another embodiment, a method for operating a centrifugal-microfluidic cartridge module according to the invention as mentioned above may have the steps of: applying an overpressure for conveying a liquid and/or gas from the first chamber to the second chamber by means of means for generating pressure which have heating and cooling means; and applying an underpressure for transporting a liquid and/or gas from the second chamber to the third chamber by means of the means for generating pressure.

Embodiments of the present invention provide: a centrifugal-microfluidic cartridge module for operation in a centrifugal-microfluidic device and/or a centrifuge. The cartridge module comprises a first chamber, a second chamber and a third chamber. The first chamber is configured to receive a fluid and/or a gas and to provide the fluid and/or the gas with a underpressure (negative pressure) and/or overpressure (positive pressure) in relation to a starting pressure by means of means for generating pressure. Furthermore, the cartridge module comprises a node (or junction) which is connected to the first, second and third chambers via a fluidic network. The fluidic network has a first partial channel (TK1) which connects the node to the first chamber, a second partial channel (TK2) which connects the node to a second chamber, and a third partial channel (TK3) which connects the node to the third chamber. A second channel (K2) connects the second and third chambers to each other, the second channel opening in a radially outer region or at the radially outer end of the second chamber and has at least one radially inwardly directed portion. The third partial channel (TK3) has a portion which, as seen radially, runs further inward than the second partial channel (TK2).

Embodiments of the present invention are based on the finding that a fluid can be pumped back and forth between three chambers or can be pumped from a first into a second chamber and from a second into a third chamber when these three chambers are connected to one another by a fluidic network, namely in that the fluidic network with a central node directly connects all the chambers, the second chamber (reaction chamber) and the third chamber (target chamber) being connected with a further connection, for example a direct connection. This pumping from the first chamber to the second chamber to the third chamber can be achieved precisely by the skillful arrangement of this connection on the second chamber and the spatial radial arrangement or the corresponding configuration of the fluidic resistances of the partial channels and channels. The individual pumping activities are controlled by a, in comparison with a starting pressure, underpressure or overpressure to be generated in the first chamber. In the case of overpressure, conveying the fluid from the first chamber to the second chamber is effected, while in the case of underpressure conveying the fluid from the second to the third chamber is effected. The advantage and distinction with respect to the known technology is sequentially pumping a liquid into different chambers with the aid of a single chamber for generating pressure (underpressure/overpressure). In particular, the possibility of pumping the liquid from a vented chamber into one or more target chambers in a last step cannot be realized with the known technology without additional microfluidic actuation structures. The procedure of configuring the intermediate structure such that it can be used for liquid transport in the first pumping operation, but has a very high fluidic resistance in the second pumping operation and thus cannot be used for pressure reduction is not apparent to the person skilled in the art.

According to embodiments, the second partial channel (TK2) has a higher fluidic resistance than the second channel (K2). This relates to the (same) fluid or gas. Possible implementations of this variation are varying the cross-section and/or the length.

According to the embodiments, the second channel (K2) and second partial channel (TK2), as seen radially, run further outward when compared to the third partial channel (TK3). During transport of the liquid from chamber 1 to chamber 2 by means of overpressure, as a result of the rotation and the resulting centrifugal forces in the second and third partial channels (TK3), the fluid is conveyed via the second partial channel (TK2) to the second chamber starting from the node, wherein the overpressure effects conveying the fluid from the first chamber to the node.

According to embodiments, when a underpressure is applied, the fluid is conveyed from the second chamber in the direction of the first chamber, but via that path which has the lower fluidic resistance. Starting from a fluid in the second chamber, the second channel (K2) has the lower fluidic resistance when compared to the second partial channel (TK2) so that the fluid is conveyed from the second to the third chamber. It is thus advantageously possible to effect conveying the fluid from the second to the third chamber by a underpressure, while according to embodiments the fluid is effected from the first to the second chamber in the case of overpressure (see above). According to an alternative variation, a geometric arrangement of the vertices of the second channel (K2) and of the second partial channel (TK2) can be used instead of or in addition to the fluidic resistance. According to embodiments, the cartridge module has a vertex in the second channel (K2) which lies radially further to the outside than a vertex of the second partial channel (TK2) so that a smaller maximum hydrostatic counterforce is effected on the fluid and/or the gas when filling the second channel (K2) than when filling the second partial channel (TK2). In this way, the pumping process from the second chamber to the third chamber can be realized advantageously.

According to embodiments, the means for generating pressure have, for example, means for tempering the fluid and/or the gas. These are, in particular, heating and/or cooling means which are configured to generate the overpressure by means of a temperature increase and the underpressure by means of a temperature reduction in the first chamber. These heating and/or cooling means can be applied either only locally to specific parts of the microfluidic structure (e.g. via one or more Peltier elements which are located in the vicinity of these parts of the microfluidic structure) or to the complete cartridge (e.g. via heating or cooling the space in which the cartridge is located during liquid actuation).

According to embodiments, a container can be or become inserted in the first chamber, wherein the container is opened in the first chamber on account of an acceleration and/or combination of hydrostatic force resulting from an acceleration and temperature increase. This therefore means that the first chamber is configured to open a container in the first chamber on account of an acceleration and/or combination of hydrostatic force resulting from an acceleration and temperature increase. The acceleration and/or temperature increase is controlled, for example, by a controller.

According to embodiments, the cartridge module has a controller and is connected to a controller which is configured to effect a pumping process of a fluid from the first chamber to the second chamber by an increase in the temperature in the first chamber and optionally additionally a reduction in a rotational frequency of the cartridge module. Alternatively, the controller is configured to induce a pumping process of the fluid from the first chamber into the second chamber by a temperature increase and optionally additionally a reduction in the rotational frequency of the cartridge module, wherein the pumping process is characterized in that the overpressure in the first chamber is sufficiently high to convey the liquid via the vertex of the inverse siphon formed by TK1 and TK2. In this case, the overpressure is less than the pressure which would be necessary to convey the liquid via the vertex of the inverse siphon formed by TK1 and TK3.

According to further embodiments, the controller is configured to effect a temperature reduction of the fluid in the first chamber. In this case, a underpressure can thus be generated in the first chamber, which acts on the fluid in the second chamber via the first partial channel (TK1) and the second partial channel (TK2) or else via the first partial channel (TK1), the third partial channel (TK3) and the second channel (K2). According to embodiments, conveying the fluid from the second chamber into the third chamber is then effected by this underpressure, as has already been explained above.

According to embodiments, the third chamber has a connection to the second channel which is arranged radially further to the inside than the maximum possible filling level of the third chamber.

According to a further embodiment, the node is formed by a further chamber. As a result, it is advantageously possible to prevent the third partial channel (TK3) from being filled with liquid during the first pumping process. For this purpose, for example, the mouth of the third partial channel (TK3) into the chamber can be formed such that it is located at the upper edge of the chamber and thus lies above the maximum possible filling level. According to a further embodiment, it is then possible for additional chambers to be provided between the node and the second chamber, for example in the form of a type of cascading. According to embodiments, the second partial channel (TK2) is configured to retain a portion of the fluid during the transport of the fluid from the first chamber to the second chamber. This can be effected by, among other things, a corresponding arrangement of the channels on additional chambers, with the result that they do not empty completely.

According to embodiments, the cartridge module is configured to be arranged in a centrifuge and/or to be centrifuged by means of a centrifuge. This means that, according to embodiments, a centrifuge with a corresponding cartridge module is provided. According to an embodiment, the first chamber, the second chamber and the third chamber are rotatable about an axis of rotation or common axis of rotation.

According to an embodiment, a direct connection can be provided between the first chamber and the third chamber. Such a structure makes it possible, for example, to dilute the liquid with the starting liquid after flowing into the third chamber.

According to an embodiment, one or more further third chambers are provided parallel to the third chamber, which are arranged between the third partial channel (TK3) and the second channel. As a result, splitting of the fluid into several chambers can be achieved.

It is to be noted here that the liquid does not necessarily have to be present directly in the first chamber, but rather is also provided as a type of tubular bag or in particular stickpack.

A further embodiment provides a method for operating a cartridge module, comprising:
applying an overpressure for conveying a fluid and/or gas from the first chamber to the second chamber; and
applying an underpressure for transporting a fluid and/or gas from the second chamber to the third chamber.

### BRIEF DESCRIPTION OF THE DRAWINGS

Embodiments will be explained below referring to the appended figures, in which:

FIG. 1 shows a schematic illustration of a microfluidic layout according to a basic embodiment of the invention;

FIG. 2 shows a schematic illustration for illustrating the principle of the publication by Thio et al.;

FIG. 3 shows a schematic illustration of the switching principle of the publication by Jülg et al.;

FIG. 4 shows an illustration of the layout and of the fluidic operation 1 and 2 in L. Malic et al.;

FIG. 5 shows a layout of DE 10201620785 A1;

FIG. 6 shows a schematic illustration of a microfluidic structure for discussing its the mode of operation according to embodiments;

FIGS. 7a-e show a schematic illustration for illustrating an embodiment for sequentially transporting the liquid according to embodiments;

FIG. 8 shows an illustration of an embodiment for sequentially transporting the liquid with additional dilution of the liquid in the target chamber according to embodiments; and

FIG. 9 shows a schematic illustration of an embodiment in which aliquoting the liquid is made possible with a second pumping step.

### DETAILED DESCRIPTION OF THE INVENTION

Before embodiments of the present invention are explained below with reference to the attached drawings, it is to be pointed out that elements and structures having the same effect are provided with the same reference numerals so that the description thereof is mutually applicable or interchangeable.

Before further details of embodiments will be discussed, the physical principles of action behind the embodiments will be explained.

Fluidic resistance: The fluidic resistance of a channel can be defined as the quotient of the pressure drop Ap in a channel and the flow rate q:

$$R = Δ p / q .$$

Depending on the channel cross-sectional geometry, the pressure drop can be analytically derived or approximated. The fluidic resistance of a channel can be determined, for example, by measuring the pressure drop and the flow rate. If nothing else is indicated here, it can be assumed that fluidic resistances for the same fluids at the same temperatures are compared.

Hydrostatic pressure by centrifugation: The hydrostatic pressure phydrostatic on a liquid column in a channel in the centrifugal gravitational field can be calculated with the following formula:

$${Δ}_{{p}_{hydrostatic}} = \frac{ρ}{2} * {ω}^{2} * ( {r}_{a}^{2} - {r}_{i}^{2} ) .$$

Thus, ρ stands for the density of the liquid, ω for the angular speed at which the channel rotates about the center of rotation, rₐ for the outer radius of the liquid column and rᵢ for the inner radius of the liquid column. This formula is also valid if the liquid column is not limited to a channel but, for example, partially fills a chamber and a connected channel.

Total pressure: The pressure generated in a chamber is composed of two components: a vapor pressure generated by the ideal gas law and a vapor pressure produced by the evaporation of the liquids. The total pressure of the system pₜₒₜₐₗ can be described by the following formula:

$${p}_{total} = {p}_{gas} + ϕ {p}_{vapor} ( T ) = \frac{nRT}{V} + ϕ {p}_{vapor} ( T ) .$$

Thus, ρ_{gas} describes the pressure which is generated by the ideal gas law, and pᵥₐₚₒᵣ the pressure which is produced by the evaporated liquid. The formula for the proportion of the vapor pressure are generally empirically determined correlations which are determined individually for each liquid and depend on the temperature. φ describes the relative humidity of the gas. At 100%, the gas is completely saturated with a liquid. In microfluidic structures, the gas is generally completely saturated.

Examples of fluidic structures, e.g. microfluidic structures, are fluid channels and fluid chambers. Fluidic structures can define an overflow structure with the aid of which liquid volumes can be measured. The basic principle here is that the liquid initially fills a chamber with a defined volume and the remaining liquid is then transported into a further chamber. Compression chambers are chambers which have either no venting or only venting with high fluidic resistance. As a result, a pressure pₜₒₜₐₗ can be built up in these chambers which is described in the formula defined above.

As is apparent to persons skilled in the art, the expression liquid as used herein also includes, in particular, liquids which contain solid constituents, such as e.g. suspensions, biological samples and reagents. In particular, this includes buffer solutions, such as e.g. lysis buffer, binding buffer, wash buffer and elution buffer, as are used in laboratory analysis and mobile diagnostics.

An inverted siphon channel is understood herein to mean a microfluidic channel or portion of a microfluidic channel in a fluidic module (of a centrifugal microfluidic cartridge), in which inlet and outlet of the channel have a greater distance from the center of rotation than an intermediate region of the channel. A siphon vertex is understood to mean the region of an inverse siphon channel in a fluidic module with minimal distance from the center of rotation.

If the expression radial is used herein, this means radial with respect to the center of rotation about which the fluidic module or the rotation body is rotatable. In the centrifugal field, a radial direction from the center of rotation is thus radially decreasing and a radial direction towards the center of rotation is radially increasing. A fluid channel whose start lies closer to the center of rotation than its end is thus radially decreasing, whereas a fluid channel whose start is further away from the center of rotation than its end is radially increasing. A channel which has a radially increasing portion thus has directional components which increase radially or run radially inward. It is clear that such a channel does not have to run exactly along a radial line, but can run at an angle to the radial line or in a curved manner.

If nothing contrary is indicated here, room temperature (20° C.) can be assumed with regard to temperature-dependent variables.

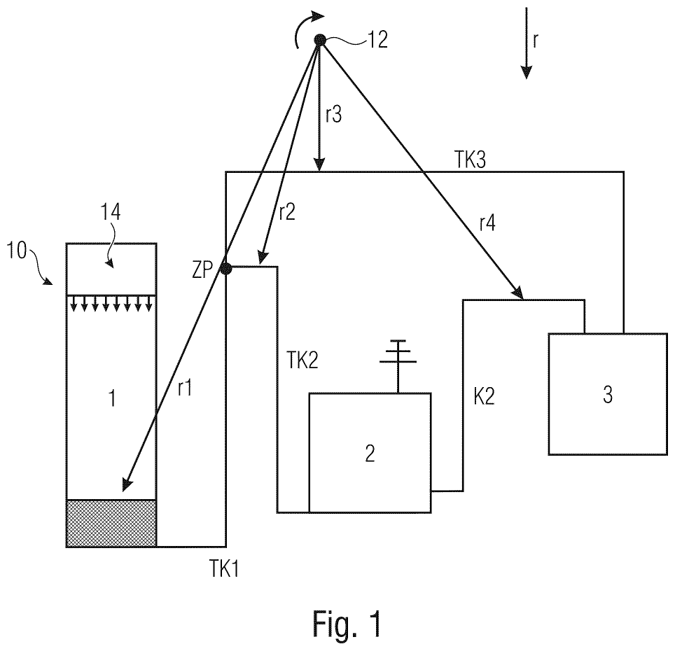

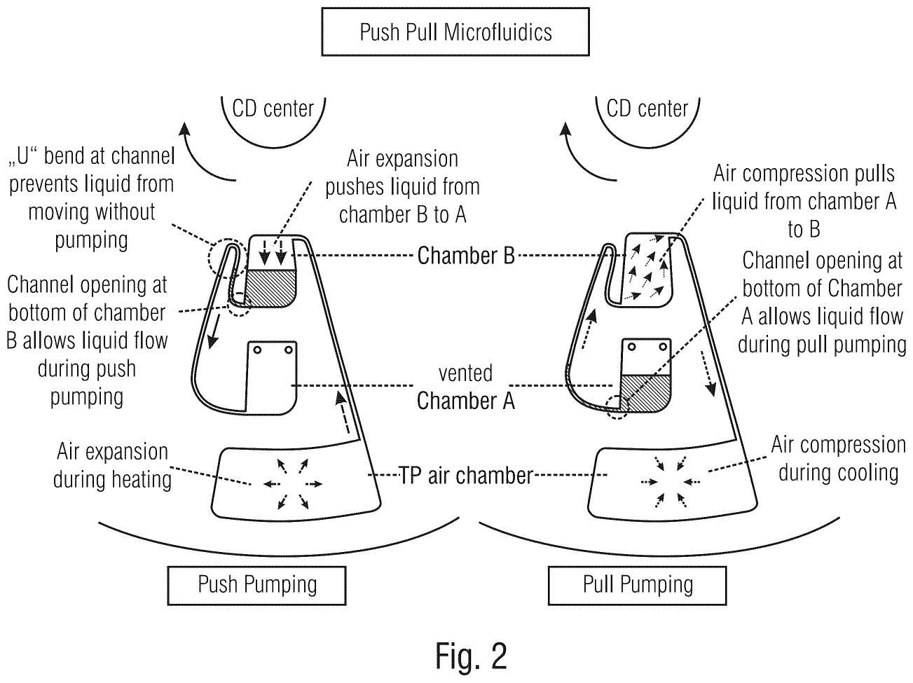

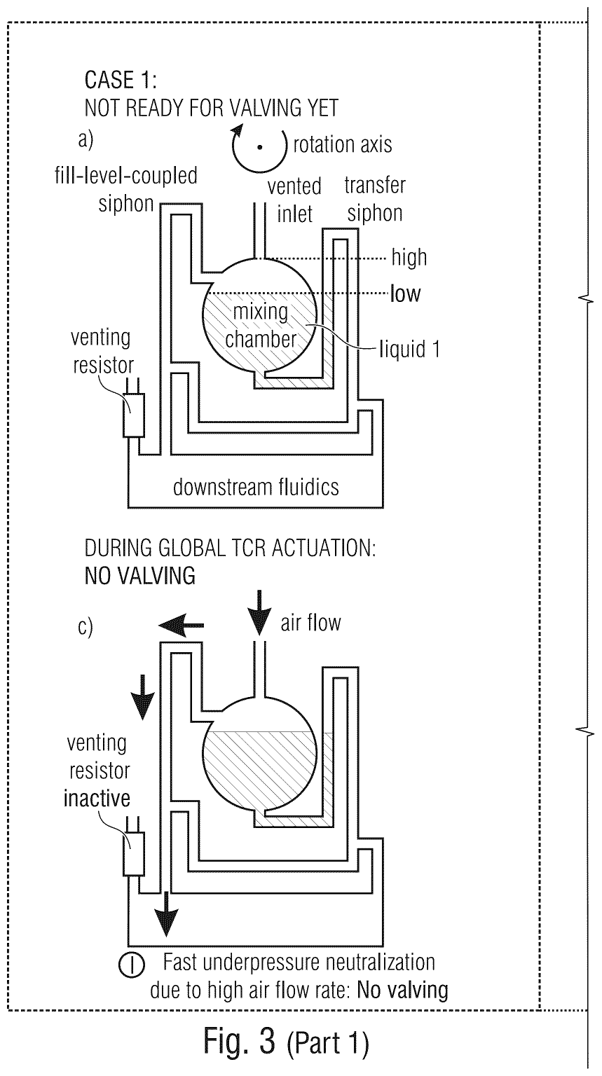

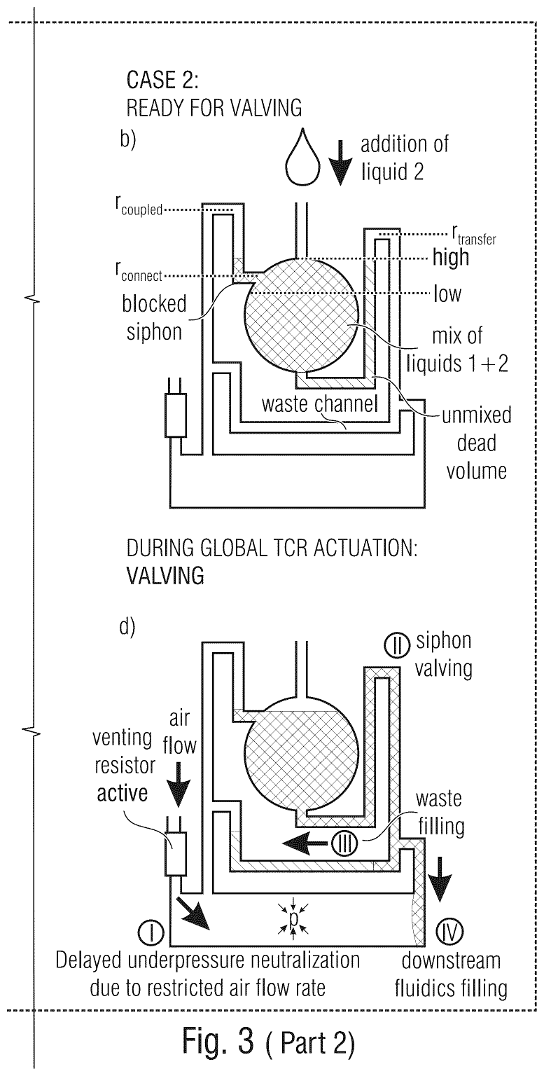

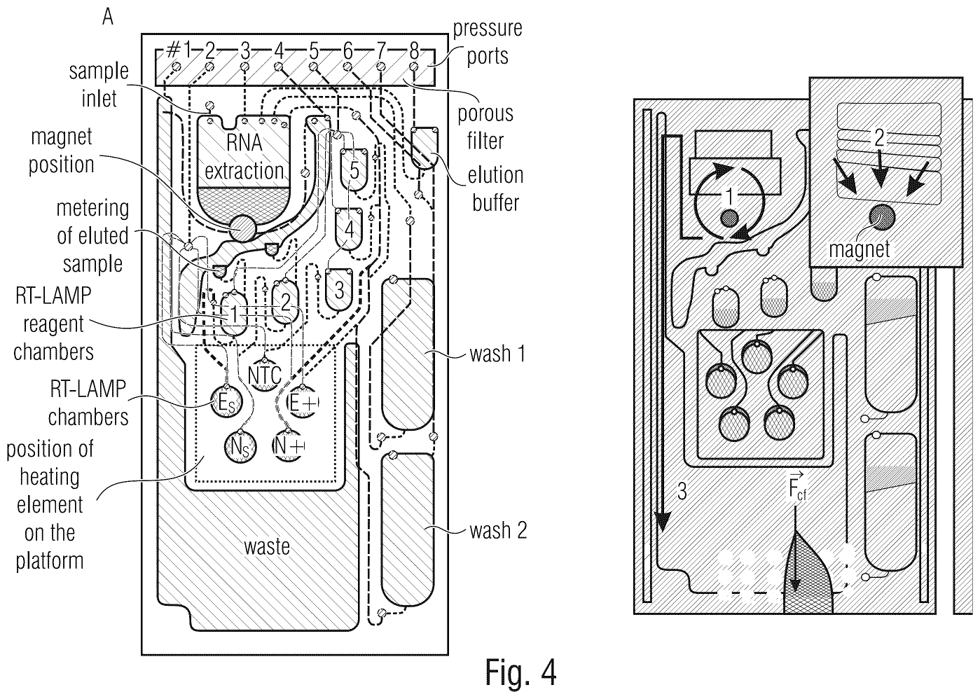

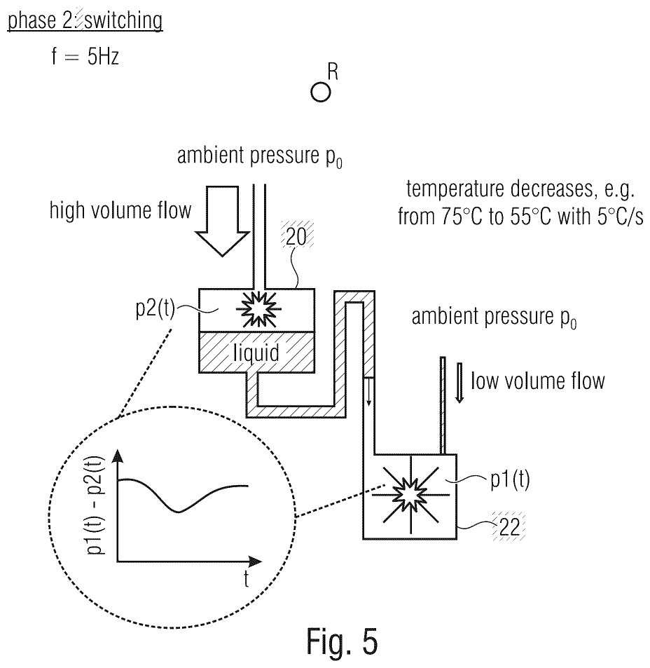

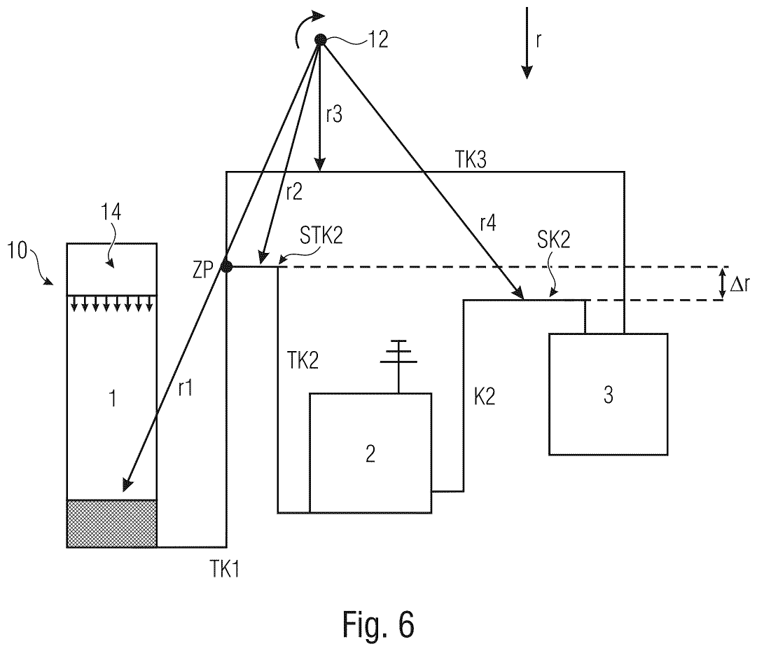

FIG. 1 shows a centrifugal-microfluidic cartridge module for operation in a centrifugal-microfluidic device or a centrifuge. The cartridge module 10 has three chambers 1, 2 and 3, wherein the first chamber 1 can be referred to as the outlet chamber, the second chamber 2 can be referred to as the reaction chamber and the third chamber 3 can be referred to as the target chamber. Chamber 2 is vented here as illustrated, this venting being either directly into the surroundings or a connection into the remaining fluidic network of the cartridge module. The three chambers are connected to one another via a fluidic network, wherein the fluidic network has a central node ZP. The central node ZP is located between the three chambers 1, 2 and 3 and connects these to one another. For this purpose, the fluidic network has a first partial channel (TK1), a second partial channel (TK2) and a third partial channel (TK3). The first partial channel (TK1) connects the node (ZP) to the first chamber. The second partial channel (TK2) connects the node (ZP) to the second chamber. The third partial channel (TK3) connects the node (ZP) to the third chamber. Furthermore, the second chamber is connected to the third chamber directly via a further channel, which is referred to as second channel (K2) below. All three chambers (1, 2 and 3) and the fluidic network consisting of TK1+TK2+TK3+ZP+K2 are mechanically coupled to one another so that they can be rotated together, for example in a centrifuge (not illustrated), about the axis of rotation 12 with the radius R. Depending on the element, chamber 1, chamber 2, chamber 3 or central node ZP, the radii R are different from the axis of rotation 12. As a result, the fluids in the individual chambers (1, 2, 3) or channels (TK1, TK2, TK3, K2) experience different centrifugal forces. As a result of these centrifugal forces during rotation and the change in the pressure in chamber 1, the fluid is moved in the fluidic network or from chamber 1 to chamber 2 to chamber 3. An actuator system is used to control the individual pumping processes, for example from chamber 1 to chamber 2 or from chamber 2 to chamber 3. According to embodiments, this actuator system comprises means for generating pressure in the chamber 1. These means are provided with the reference numeral 14 and according to embodiments can be implemented by temperature control means. By means of temperature variation, an overpressure and/or underpressure can be generated in the chamber 1 in relation to a starting pressure, for example a starting pressure in the system comprising the components 1, 2, 3, TK1, TK2, TK3 and K2. By heating the fluid in the chamber 1, an overpressure is generated in the same. After the first pumping process, this overpressure generally decreases via the fluidic network. By reducing the temperature, an underpressure in relation to the starting pressure is then generated in the chamber 1 in a second step, before the temperature decrease. According to embodiments, the means for generating pressure 14 therefore comprise means for generating heat, such as a heater, and means for cooling the fluid in the chamber 1.

After having explained the structure, the mode of operation will be discussed below.

The structure of the centrifugal-microfluidic cartridge 10 enables, with the aid of the liquid/the gas from a chamber 1 acting as a compression chamber, a pumping process into a second, e.g. vented, chamber 2 in a pumping step 1, and a further pumping process (pumping step 2) into a third chamber 3. This second pumping step follows the first pumping step, for example, and can be referred to as a separate step. The pumping step 1 is controlled or separated from the pumping step 2 by the means for generating pressure 14.

In addition to the centrifugal force, chamber 1 acts as an actuator for liquid transfer in the centrifugal-microfluidic structure, in that either overpressure or underpressure is applied to at least parts of the remaining centrifugal-microfluidic structure by heating or cooling the liquid/gas located in chamber 1. The liquid is transported from chamber 1 to chamber 2 by means of overpressure, and the liquid is transported from chamber 2 to chamber 3 by means of underpressure. The core of the invention is that a relatively high fluidic resistance when compared to channel K2 is present in the intermediate structure (TK2) after pumping step 1 either inherently due to the design (small structures with high fluidic resistance) and/or on the basis of residual liquid which remains in the intermediate structure after pumping step 1. Accordingly, for the pumping step 2, the underpressure can be applied to the liquid located in chamber 2 via the channels TK1 and TK3, chamber 3 and channel K2, and the liquid can be transferred to chamber 3 via channel K2. The liquid is advantageously pumped through channel K2 to chamber 3 on account of the different fluidic resistances of the intermediate structure and channel K2.

With regard to the exemplary embodiment from FIG. 1, it is to be noted that a distinction can be made between two different implementations in the fluidic network, wherein mixed forms can also be used. Both implementations have in common that the second channel (K2) connects the second chamber and third chamber to each other, specifically in a radially outer region or at the radially outer end of the chamber 2 (mouth of the chamber 2). Furthermore, the second channel (K2) has at least one radially inwardly directed portion. Radially inward means toward the axis of rotation 12 (closer to the axis of rotation). The third partial channel (TK3) furthermore has a portion which, as seen radially, runs further inward than the second partial channel (TK2). Starting from this basic structure, according to a first variation, the second partial channel (TK2) can have a higher fluidic resistance than the second channel (K2) with respect to the same liquid or gas. According to a second variation, a vertex in the second channel (K2) can be further radially outward than a vertex in the second partial channel (TK2) so that the hydrostatic pressure which has to be overcome on account of the rotation during the second pumping process is lower in the second channel (K2) than in the second partial channel (TK2). The vertex in the second channel (K2) is provided with SK2 and the vertex in the second partial channel (TK2) is provided with STK2. The radial difference of the two vertices is characterized by Ar. If the underpressure meets the condition that it is smaller than the hydrostatic pressure acting in the second partial channel (TK2) when STK2 is reached, and greater than the hydrostatic pressure in the second channel (K2) when SK2 is reached, the liquid is transferred exclusively into the third chamber since the siphon consisting of TK1, ZP and TK2 cannot be primed. Both variations make it possible, when an underpressure is applied in the first chamber by means of the element 14, to control the pumping process 2 such that a large part of the liquid is transferred from chamber 2 to chamber 3.

The setup explained above will be described again in other words below and optional aspects will be discussed here. Chamber 3 can be arranged arbitrarily with respect to chamber 2 (i.e., for example, in particular also radially inwards). Chamber 2 and chamber 3 are connected via a channel (K2). Chamber 3 is furthermore connected to a node (ZP) by a channel TK3. The node can be implemented here as a T-piece (meeting of three channels) or as a chamber. An intermediate structure (TK2), which in this case consists of at least one channel and no or at least one intermediate chamber, leads from this node to chamber 2. Chamber 1 is also connected to the node via the channel TK1.

In the present device, the actuation principle is as follows: In addition to other possibilities, temperature or frequency changes are often used as actuation principles in centrifugal microfluidics in order to generate the necessary pressure in compression chambers and thus to enable liquid transport. A disadvantage of current solutions is the space requirement due to a multitude of compression chambers in order to be able to realize sequential pumping steps.

The method behind this can then be described as follows: The liquid in chamber 1 can be upstream, for example, in a tubular bag (stickpack). Stickpacks can be opened during processing by a centrifugal force or a combination of centrifugal force and temperature, which results in a release of the liquid. By increasing the temperature in chamber 1, an overpressure is built up in the same. Subsequently, the frequency is reduced to such an extent that the overpressure in chamber 1 is greater than the maximum possible centrifugally induced hydrostatic pressure in partial channel TK1. In this case, the inner radius is the position of the node (corresponds to the vertex of the inverse siphon which is formed by the partial channels TK1 and TK2) and the outer radius corresponds to the radial position of the liquid meniscus in chamber 1.

The overpressure in chamber 1 is, however, lower than the maximum possible hydrostatic pressure in the partial channels TK1 and TK3. By suitably selecting the overpressure in chamber 1 and the rotational frequency of the cartridge module, it is ensured that the liquid is pumped from chamber 1 exclusively via channel TK2 to chamber 2. Towards the end of the pumping process, the pressure in chamber 1 equalizes via TK1, TK2 and TK3 with the pressure level in the remaining fluidic cartridge, wherein the temperature in chamber 1 is still increased.

No liquid is pumped through channel TK3; it merely serves for gas exchange between chamber 1 and chamber 3 as soon as the liquid has been pumped from chamber 1 and the channels TK1 and TK3 are filled with gas. In order to realize the second pumping process, chamber 1 is cooled, thereby producing an underpressure with respect to the remaining pressure level in the microfluidic cartridge in this chamber. The underpressure acts on the liquid in chamber 2 via the channels TK1 and TK2, on the one hand, and via the channels TK1, TK3 and K2, on the other hand. Thus, the fluidic resistance of channel TK2 is so high in relation to channel K2 that the liquid does not reach the branching point of TK1, TK2 and TK3 (ZP) during the pumping process and is therefore pumped almost completely to chamber 3 via channel K2.

All embodiments have in common that they describe a microfluidic structure with which a liquid can be pumped sequentially into several successively connected, e.g. vented, chambers, exclusively by means of a single compression chamber. Possible applications here are extracting and purifying DNA, in which liquid reagents, such as e.g. lysis, binding, washing and elution buffers, are at first pumped from a pre-storage chamber 1 into a reaction chamber 2 and, after the reaction, pumped further into a target chamber 3.

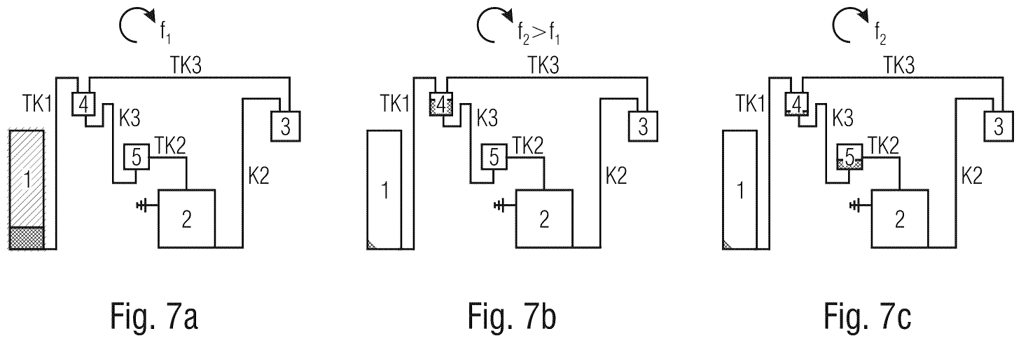

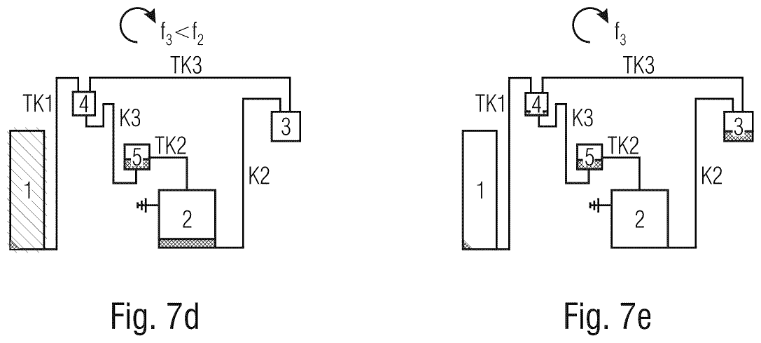

According to a further embodiment, the structure explained above can be expanded by further chambers. In the variation illustrated in FIGS. 7a-e, there is, in addition to the three chambers 1, 2, 3 (outlet chamber, reaction chamber and target chamber), a further chamber 5, which is arranged between the central node and the chamber 2. In this embodiment, the central node is also formed by a further chamber 4. The two additional features, namely using a chamber 4 as node and providing a chamber between the node and the reaction chamber, can be used together, but also individually on their own. The channel portion between the chamber 4 and the chamber 5 is provided here with the reference numeral K3. According to optimal embodiments, K3 can have a (high) fluidic resistance, e.g. a higher fluidic resistance than the channel K2 between chamber 2 and 3.

In FIGS. 7a-c, the pumping process from the outlet chamber 1 into the reaction chamber 2 is illustrated, wherein it is assumed that the outlet chamber 1 is heated in the sequences illustrated in FIGS. 7a-c. In FIGS. 7d and 7e, the second pumping process is illustrated, in which the outlet chamber 1 is cooled. After having explained the structure and also the illustration of the embodiment from FIGS. 7a-d, the mode of operation will be discussed. It is to be noted that the rotation frequency f2 is greater than the rotation frequency f1 and f3. The additionally inserted structures, in particular the chamber 5 with the upstream channel K3, increase the robustness during operation and enable an easier configuration. The implementation of the node as a chamber also contributes to this.

Furthermore, a chamber 5 was introduced in the intermediate structure, which chamber retains a defined amount of volume of liquid as a result of its geometric configuration as an overflow chamber. This makes it possible to ensure that the channel K3 always remains filled with liquid after first liquid flows through the same and thus an effective pumping process from chamber 2 into chamber 3 can take place. In this embodiment, the underpressure generated in chamber 1 acts on the liquid in chamber 2 only via the fluidic path TK1, chamber 4, TK3, chamber 3 and K2. In the initial state, liquid is located in chamber 1 (FIG. 7a). By increasing the temperature (locally or globally), an overpressure Protal is generated in chamber 1. Above a certain temperature, the overpressure generated in chamber 1 is greater than the centrifugally induced hydrostatic pressure on the liquid in channel TK1. As a result, the liquid is pumped from chamber 1 to chamber 4 (FIG. 7b). As soon as the total liquid volume has been pumped into chamber 4, the overpressure is completely equalized via channel TK1, TK3 and K2 and the vented chamber 2. By increasing the rotational frequency, the liquid is subsequently first transferred from chamber 4 through channel K3 to chamber 5 and a part of the liquid is then transferred through TK2 to chamber 2 (FIG. 7c).

In this embodiment, a part of the liquid remains in chamber 5, which is implemented as an overflow structure, while the large part of the liquid is transferred further into the vented reaction chamber (chamber 2) directly via channel TK2 (FIG. 7d). In chamber 2, any reaction can take place subsequently. This can be, for example, the elution of biomolecules from a solid phase. By a temperature reduction, an underpressure is subsequently generated in chamber 1. Since the chambers 3 and 4 are connected to chamber 1 via the channels TK3 and TK1, an underpressure is also present in these chambers. When the rotational frequency of the cartridge is reduced, the centrifugal pressure on the liquid in channel K2 drops, and the liquid is pumped to chamber 3 by means of the underpressure present in chamber 3. At the same time, the liquid remaining in chamber 5 is also pumped to chamber 4 through channel K3. Usually, channel K3 has a higher fluidic resistance than channel K2 in order to ensure that the pumping process in chamber 3 is first concluded, even in the case of a low volume in chamber 5.

It is essential for the mode of operation in this embodiment that liquid remains in chamber 5 and channel K3, and thus no abrupt pressure equalization can take place via the channels K3 and TK2 when the temperature is lowered.

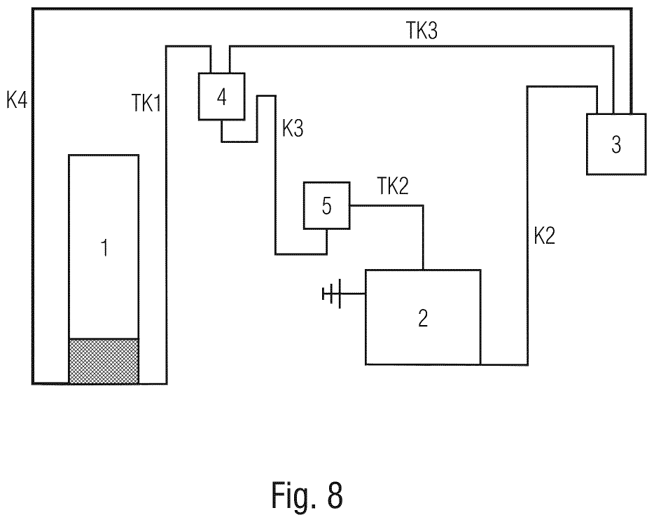

Further embodiments are conceivable. Thus, as illustrated in FIG. 8, parallel to the pumping of the liquid from chamber 1 to chamber 4, a part of the liquid can be pumped from chamber 1 to the target chamber (chamber 3), wherein the ratio of the pumped volumes depends on the resistance ratio of the channels TK1 and K4. Such a microfluidic structure makes it possible, for example, to dilute the liquid with the starting liquid after the reaction in the target chamber. It is to be noted here that, according to embodiments, the partial channel TK1 can form a type of siphon which, as seen radially, is located further inward than the chamber 1 or the liquid level of the chamber 1 (liquid level of the chamber 1 located farthest inward as seen radially). Alternatively, the central node can also be located further inward than the chamber 1 or the liquid level of the chamber 1 located farthest inward. Here, in this embodiment, as already mentioned above, the central node is formed by the chamber 4. This is due to the fact that, solely due to the rotational force, no liquid is conveyed in the direction of the central node. Here, the chamber 4 forms the central node, for example.

It can furthermore be seen here that the chamber 2, i.e. the reaction chamber, can be vented according to embodiments.

Even if it was assumed in the above embodiments that the means for generating pressure can be provided by means for controlling the temperature, such as for example for heating or cooling, according to further embodiments, a different principle for generating pressure, e.g. a chemical reaction or mechanical volume reduction, could also be used.

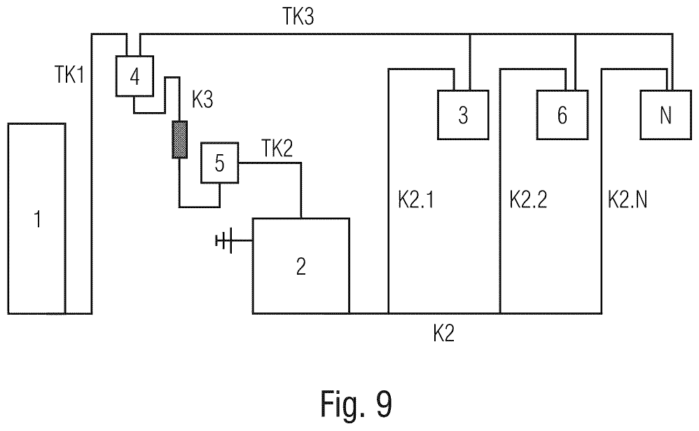

A further embodiment can be seen in FIG. 9. It is thus possible to place further chambers next to chamber 3. These chambers are also connected to channel TK3. Channel K2 branches off from chamber 2 and splits into channels K2.1, K2.2, . . . , K2.N. Aliquoting the liquid in the second pumping step is made possible by such a structure. The aliquoted volumes in this case depend on the fluidic resistances of the channels K2.1, K2.2, . . . , K2.N.

### Alternatives

Further embodiments will be outlined below with reference to the above figures.

A further embodiment provides a fluidic module which is rotatable about a center of rotation. The fluidic module comprises:
a) a chamber 1 which is not vented,
b) having at least one outlet channel (TK1) which is attached to the chamber radially on the outside and opens into a node,
c) wherein an intermediate structure leads from the node to a chamber 2,
d) wherein a channel leads from the node to a chamber 3,
e) wherein the chamber 1 is partially filled with liquid, partially filled with a compressible medium,
f) a chamber 2,
g) wherein chamber 2 is fluidically connected to chamber 1 via an intermediate structure and to a chamber 3 via channel K2,
h) wherein the intermediate structure has a higher fluidic resistance for the same medium to flow through than channel K2,
i) wherein chamber 2 can have further connections to a fluidic network.

According to embodiments, the chamber 2 can be vented via a channel.

According to further embodiments, the node can be formed as a T-piece (meeting of three channels or partial channels).

According to further embodiments, the node can be implemented as a chamber.

According to further embodiments, the partial channel TK3 between the central node and the third chamber can be radially inwards, i.e. lead into the chamber at the node such that the mouth of the channel into the chamber always is above the maximum possible filling level of the chamber.

According to embodiments, the means for generating pressure are configured to generate the underpressure and/or the overpressure independently of the rotation or at least to vary independently of the rotation. For example, the overpressure or the underpressure can be generated or regulated by additional temperature input or cold input.

According to embodiments, the partial channel TK1 is connected to the central node ZP such that the central node ZP, as seen radially, is located further inward than the liquid level in the first chamber. It is thus prevented that a pumping process is triggered by the rotation alone or
in other words—it is ensured that the pumping process is actively regulated by the means for generating pressure.

According to further embodiments, at least one further chamber can exist in the intermediate structure, which is configured such that a part of the liquid which flows from the chamber 1 into this chamber always remains in the connecting channel of these two chambers.

According to a further embodiment, the chamber 1 can have a further outlet channel which connects this chamber to the third chamber. This channel is positioned radially outwards on chamber 1 and radially inwards on chamber 3.

According to a further embodiment, the temperature of the liquid/the gas, e.g. in chamber 1, is set by a heating element. According to an embodiment, the heating element can be provided locally (only for the chamber 1) or also globally for the entire system. The same of course also applies to the cooling element which is provided either locally for chamber 1 or also globally for the entire fluidic module/system.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A centrifugal-microfluidic cartridge module for operation in a centrifugal-microfluidic device and/or centrifuge so that the cartridge module is rotatable about a rotation center, comprising:
a pressure generator; wherein the pressure generator comprises heating and/or cooling elements configured to generate the overpressure by means of a temperature increase and the underpressure by means of a temperature reduction;
a first chamber configured to receive a liquid and/or gas and to provide the liquid and/or the gas with an underpressure and/or overpressure in relation to a starting pressure by means of the pressure generator;
a second chamber;
a third chamber; and
a node which is connected to the first, second and third chambers via a fluidic network, wherein the fluidic network comprises a first partial channel which connects the node to the first chamber, a second partial channel which connects the node to the second chamber, and a third partial channel which connects the node to the third chamber;
wherein a second channel connects the second and third chambers to each other and opens in a radially outer region or at the radially outer end of the second chamber and comprises at least one radially inwardly directed portion; wherein the third partial channel comprises a portion which, as seen radially, is further inward than the second partial channel.

2. The cartridge module according to claim 1, wherein the second partial channel with respect to the liquid and/or the gas comprises a higher fluidic resistance than the second channel with respect to the same liquid and/or the same gas.

3. The cartridge module according to claim 1, wherein a vertex of the second channel is further radially outward than the vertex of the inverse siphon formed by the first partial channel and second partial channel in particular so that a smaller maximum hydrostatic counterforce acts on the liquid and/or the gas when filling the second channel than when filling the first partial channel and/or the second partial channel.

4. The cartridge module according to claim 1, wherein a container is opened in the first chamber due to an acceleration or a combination of hydrostatic force resulting from an acceleration and temperature increase.

5. The cartridge module according to claim 1, which comprises a controller or is connected to a controller which is configured to effect a pumping process of the liquid and/or gas from the first chamber to the second chamber by increasing a temperature in the first chamber and/or a reduction in a rotational frequency of the cartridge module; or
which comprises a controller or is connected to a controller which is configured to induce a pumping process of the liquid and/or gas from the first chamber into the second chamber by a temperature increase and/or a reduction in a rotational frequency of the cartridge module, wherein in the pumping process the overpressure in the first chamber is sufficiently high to convey the liquid via the vertex of the inverse siphon formed by the first partial channel and the second partial channel and/or the overpressure is less than the pressure which would be necessary to convey the liquid via the vertex of the inverse siphon formed by the first partial channel and the second partial channel.

6. The cartridge module according to claim 1, which comprises a controller or is connected to a controller, wherein the controller is configured to effect a temperature reduction of the liquid and/or gas in the first chamber; or
which comprises a controller which is configured to effect a temperature reduction of the liquid and/or gas in the first chamber in order to thus produce an underpressure in relation to a starting pressure in the first chamber, which acts on the liquid and/or gas in the second chamber via the first partial channel, the second partial channel and via the first partial channel, the third partial channel and the second channel or acts on the liquid and/or gas in the second chamber via the first partial channel, the third partial channel and the second channel.

7. The cartridge module according to claim 1, wherein the third chamber comprises a connection to the second channel which is arranged radially further to the inside than the maximum filling level of the third chamber.

8. The cartridge module according to claim 1, wherein the third chamber and/or the second channel is/are arranged radially further to the outside than the second chamber and/or the second partial channel.

9. The cartridge module according to claim 1, wherein the radially outer point of the second chamber is arranged radially further to the outside than a mouth from the second channel into the third chamber.

10. The cartridge module according to claim 1, wherein the second chamber comprises a port to the second partial channel which is located in a radially outer region or at the outermost point of the second chamber.

11. The cartridge module according to claim 1, wherein the node is formed by a further chamber.

12. The cartridge module according to claim 1, wherein an additional chamber is provided between the node and the second chamber.

13. The cartridge module according to claim 12, wherein the second partial channel, due to the higher fluidic resistance or a geometric arrangement of vertices of the second channel and the second partial channel, is configured to retain the liquid and/or gas during the transport of the liquid and/or gas from the first chamber to the second chamber.

14. The cartridge module according to claim 1, wherein the pressure generator is configured to generate or vary the underpressure and/or the overpressure independently of rotation.

15. The cartridge module according to claim 1, wherein the node and/or the vertex of the inverse siphon formed by the first partial channel and the second partial channel, as seen radially, is/are located further inward than the first chamber or the liquid level in the first chamber located farthest inward as seen radially.

16. The cartridge module according to claim 1, wherein the pressure generator acts locally on the liquid and/or the gas in the first chamber or an underpressure or overpressure acts on the liquid and/or the gas in the first chamber in relation to the liquid and/or the gas in the second chamber.

17. A method for operating a centrifugal-microfluidic cartridge module according to claim 1, comprising:
applying an overpressure for conveying a liquid and/or gas from the first chamber to the second chamber by means of a pressure generator which comprises heating and cooling elements; and
applying an underpressure for transporting a liquid and/or gas from the second chamber to the third chamber by means of the pressure generator.
